(19) United States
(12) Patent Application Publication
(10) Pub. No.: US 2024/0333644 A1
(43) Pub. Date: Oct. 3, 2024

(54) Distributed Broadband Network Gateway for Maximizing IPv4 Address Utilization

(71) Applicants: Evan Parker, San Jose, CA (US); Michael McCalpin, McKinney, TX (US); Morteza Ghodrat, Oak Park, CA (US); Mukund Kannan, Livermore, CA (US); Nitin Gupta, Freemont, CA (US)

(72) Inventors: Evan Parker, San Jose, CA (US); Michael McCalpin, McKinney, TX (US); Morteza Ghodrat, Oak Park, CA (US); Mukund Kannan, Livermore, CA (US); Nitin Gupta, Freemont, CA (US)

(21) Appl. No.: 18/141,525

(22) Filed: May 1, 2023

Related U.S. Application Data
(60) Provisional application No. 63/456,023, filed on Mar. 31, 2023.

(51) Int. Cl. H04L 45/741; H04L 61/5014; H04Q 11/00

(52) U.S. Cl. CPC H04L 45/741; H04L 61/5014; H04Q 11/0067; H04Q 2011/0073

(57) ABSTRACT

Systems and techniques for distributed broadband network gateway for maximizing IPv4 address utilization. A dynamic host configuration protocol (DHCP) offer message is received by a distributed broadband network gateways (BNG) connected to a network. The DHCP offer message may have been forwarded from a DHCP server. The DHCP offer message is modified to replace an option 1 subnet mask with a 32-bit subnet mask and replace an option 3 router address with an internet protocol address of the distributed BNG to create a modified offer message. The modified offer message is transmitted to a user computing device. A route with a 32-bit subnet mask for the user computing device is advertised to other routers internal to the network of the broadband service provider.

### PRIORITY APPLICATION

This application claims the benefit of priority to U.S. Provisional Application Ser. No. 63/456,023, filed Mar. 31, 2023, the content of which is incorporated herein by reference in its entirety.

### TECHNICAL FIELD

Embodiments described herein generally relate to computer networking and, in some embodiments, more specifically to a Distributed Broadband Network Gateway (BNG) for maximizing internet protocol version 4 (IPv4) address utilization, simplifying IPv4 address management, and simplifying network operations.

### BACKGROUND

Internet Protocol version 6 (IPv6) is available and offered by many internet service providers. However, about 23% of websites in the world use Ipv6. Internet service providers (ISP) desire to provide a way for their subscribers to access websites that do not support Ipv6. Internet Protocol version 4 (IPv4) addresses are a limited resource. The prolific utilization of Ipv4 addresses on the Internet results in a shortage of available addresses and an increased cost to obtain IPv4 addresses. A network operator may desire to efficiently manage Ipv4 utilization and to reduce waste of the limited IPv4 addresses. In addition, due to this shortage of IPv4 addresses, operators can only purchase one small IPv4 subnet at a time for their operations, and then apply a technique called multi-netting to share these small subnets across their subscribers. This technique, however, has introduced additional operational costs and challenges that the Internet Service Providers would like to avoid.

Internet Service Providers sometimes control the bandwidth allowed individual subscribers using a centralized Broadband Network Gateway (BNG). A network operator may desire to simplify their network operations by eliminating this centralized BNG.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example of conventional internet protocol (IP) subnet and address assignment for IPV4 addresses.

FIG. 2 is a diagram of an example architecture for a distributed broadband network gateway for maximizing IPv4 address utilization, according to an embodiment.

FIG. 3 is a block diagram of an example of a system for a distributed broadband network gateway for maximizing IPv4 address utilization, according to an embodiment.

FIG. 4 is a dataflow diagram of an example of an address assignment process for a distributed broadband network gateway for maximizing IPv4 address utilization, according to an embodiment.

FIG. 5 is a flow diagram of an example of a method for a distributed broadband network gateway for maximizing IPv4 address utilization, according to an embodiment.

FIG. 6 is a block diagram illustrating an example of a machine upon which one or more embodiments may be implemented.

### DETAILED DESCRIPTION

Most Internet Service Providers (ISPs) have either migrated their network to IPv6 or are in some phase of planning to do so. Migrating to IPv6 does not obviate the need to support IPv4 because there are still 77% of the websites in the world are not accessible via IPv6. There are various approaches to providing access to servers that are accessible only via Internet Protocol version 4 (IPv4), such as carrier-grade network address translation (CGNAT), however CGNAT is not compatible with some applications, including port forwarding from the Internet to servers behind a subscriber's firewall. It may also be complicated and expensive to implement, so service providers may offer their subscribers Internet Protocol (IP) addresses in the public IPv4 space to avoid these problems. The IPv4 address space has been exhausted and therefore IPv4 addresses are available to ISPs primarily through auction or lease at an increasing cost per address. Often the IP address spaces that are available for lease or purchase are available in small subnet sizes, forcing the ISP to manage the allocation of IP addresses across an increasing number of subnets and therefore increasing operational complexity.

Compounding the problem of limited availability of IPv4 address is the small layer-2 virtual local area networks (VLANs) that service provider networks are divided into to keep networking issues such as broadcast storms and network loops isolated. Each layer-2 VLAN is typically assigned a dedicated IP subnet which includes a block of IPv4 addresses sized in powers of 2, minus 2 IP addresses reserved for broadcast and network addresses. This leads to wastage of the precious IP addresses in cases where the number of subscribers on a VLAN is less than the number of IP addresses in the allocated subnet.

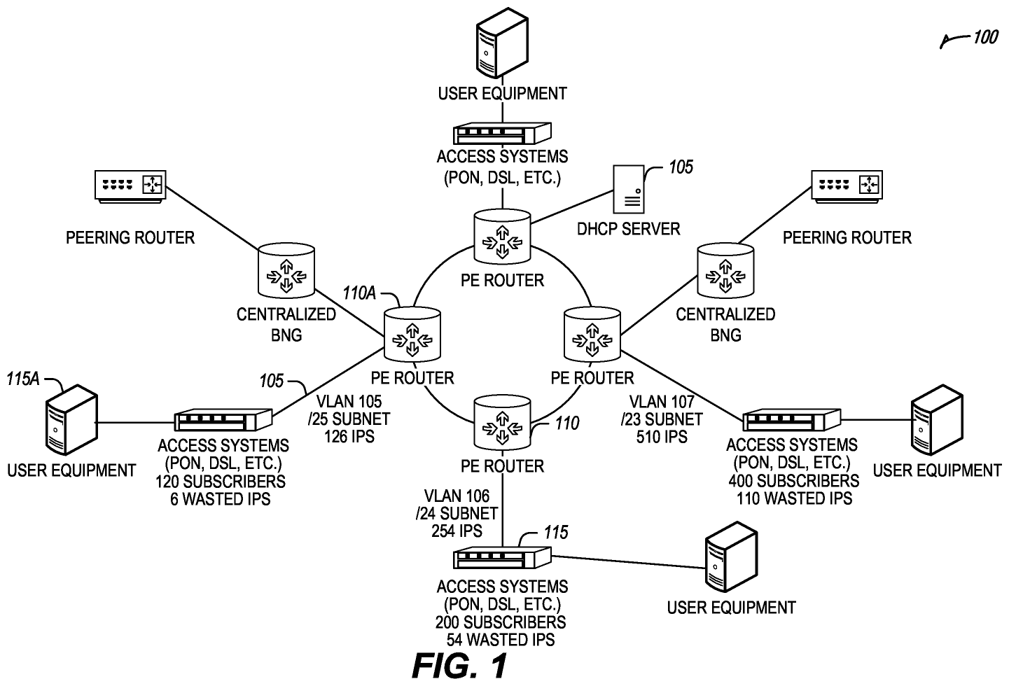

FIG. 1 is a diagram of an example of conventional Internet Protocol (IP) subnet and address assignment 100 for IPv4 addresses. FIG. 1 shows typical example locations of centralized Broadband Network Gateways (BNGs) responsible for controlling bandwidth rates associated with Internet Service Provider (ISP) subscriber service subscriptions. The VLAN 105 with a/25 subnet has 126 (e.g., 2\hat{ }\hat{ }7-2) usable IP addresses, but if there are only 120 subscribers 115A on Virtual Local Area Network (VLAN) 105, there are 6 IP addresses going unused. If the number of subscribers 115A on VLAN 105 exceeds 126, then the service provider must add another VLAN with a different IP subnet and begin provisioning subscribers 115A on the new VLAN and subnet. Unused IPv4 addresses present a capital expenditure (CAPEX) in cases where the IP addresses have been purchased at an auction or an operational expense (OPEX) overhead in cases where those IP addresses have been leased from another party. Constantly adjusting IPv4 subnets to accommodate growth or shrinkage in subscribers on a VLAN presents an additional OPEX overhead.

Also compounding the problem of limited availability is that the IP addresses that are available may not be available in convenient subnet sizes, requiring the broadband service provider (BSP) to configure multiple smaller subnets on a single VLAN which is referred to as “multi-netting.”

An alternative to breaking up the network into subnets as shown in FIG. 1 is to use large layer-2 networks with multiple IP subnets. While this alternative eliminates IPv4 address space waste due to subnets that are not fully utilized, it introduces complexity. With a large number of hosts on this layer-2 network, it is prone to common issues with layer-2 networks including, (1) network loops, (2) broadcast storms, and (3) layer-2 switch forwarding table exhaustion. Larger layer-2 networks may require layer-2 Multiprotocol Label Switching (MPLS) Virtual Private Networks (VPNs) (e.g., Virtual Private LAN Services (VPLS), Virtual Private Wire Service (VPWS), etc.) in order for the layer-2 network to traverse core routers. This increases the OPEX further due to the required maintenance of the MPLS VPNs.

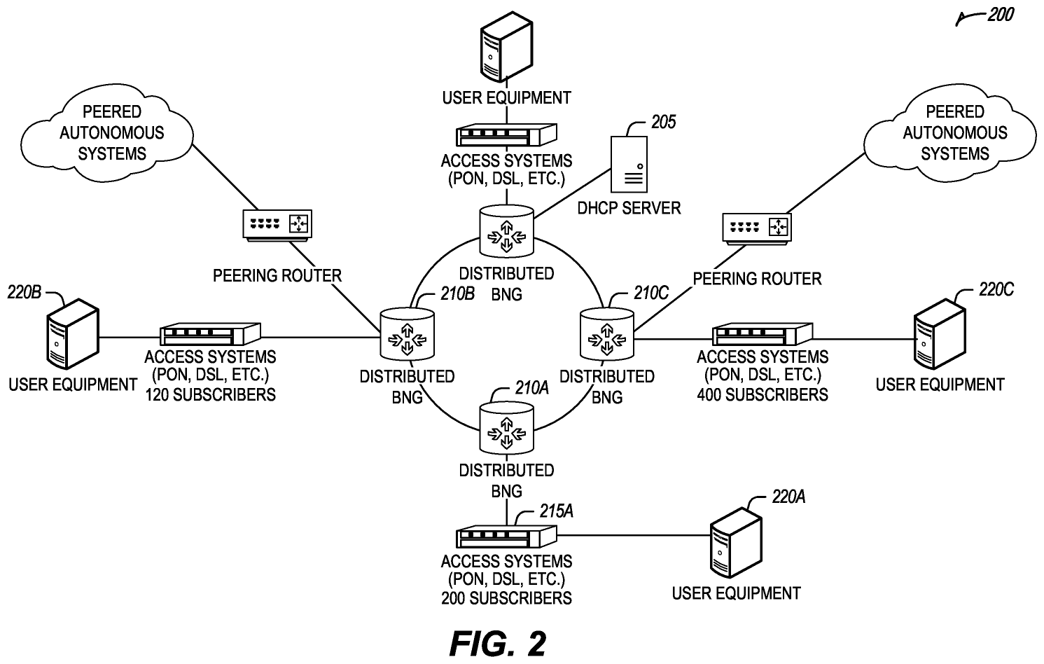

FIG. 2 illustrates a block diagram of an example of an architecture 200 for a distributed broadband network gateway for maximizing IPv4 address utilization, according to an embodiment. The architecture 200 simplifies management of IPv4 subnets and simplifies network architecture by eliminating the need for a separate centralized Broadband Network Gateway (BNG).

A broadband service provider (BSP) configures a dynamic host configuration protocol (DHCP) server 205 with IP address pools. Gateway DHCP option 3 and subnet DHCP option 1 in each pool may be configured with a variety of values. A first distributed BNG 210A, connected to a first access system 215A, modifies a DHCP OFFER provided by the DHCP server 205 with a 32-bit (e.g., all ones) DHCP option 1 subnet mask and its own IP address as the DHCP option 3 gateway. The first distributed BNG 210A advertises a route with a 32-bit subnet mask to an IP address of a first subscriber 220A via the first distributed BNG 210A IP address to the other connected distributed BNGs 210B and 210C.

The subscriber segment served by the first access system 215A with 200 subscribers 220A does not contain wasted IP addresses in contrast to the subscriber segment served by access system 115A as described in FIG. 1. This is accomplished by the first distributed BNG 210A transmitting a DHCP OFFER and DHCP ACK with a 32-bit subnet mask (DHCP Option 1) and its own IP address as the router (DHCP Option 3) to each subscriber 220A served by the first distributed BNG 210A. The first distributed BNG 210A advertises, to the other distributed BNGs 210B and 210C, a route with a 32-bit subnet mask to the IP address of user equipment of the subscriber 220A via the IP address of the first distributed BNG 210A.

A further benefit of the Distributed BNG shown in FIG. 2 is the elimination of the need for the centralized BNG shown in FIG. 1. Internet service providers often employ centralized BNGs to control the bandwidth of subscribers so the subscribers cannot consume more bandwidth than they have paid for. For example, if a subscriber is paying for 100 Mbps bandwidth, the BNG controls the bandwidth of that subscriber to ensure they don't exceed 100 Mbps. By implementing this function in the Distributed BNG shown in FIG. 2, we have eliminated the need for the centralized BNG shown in FIG. 1, simplifying the operator's network operations.

In an alternative embodiment, the Distributed BNGs 210A, 210B, and/or 210C may serve as an IP address utilization maximization engine without shaping bandwidth of subscribers. The bandwidth of the subscribers 220A, 220B, and 220C connected to them would be controlled elsewhere in the network or not at all. The ISP enjoys the benefits of the IP address utilization maximization engine, including conserving IPv4 address space and simplifying IP address management by eliminating multi-netting, for those subscribers served such an embodiment.

In an alternative embodiment, Distributed BNGs 210A, 210B, and/or 210C are shaping bandwidth of subscribers without serving as an IP address utilization maximization engine. In this embodiment, the user equipment of the subscribers 220A, 220B, and 220C receive whatever DHCP options 1 and 3 were sent by the DHCP server 205. In this embodiment, the ISP simplifies network operations by eliminating a centralized BNG and instead shaping subscriber bandwidth in routers at the edge of the network.

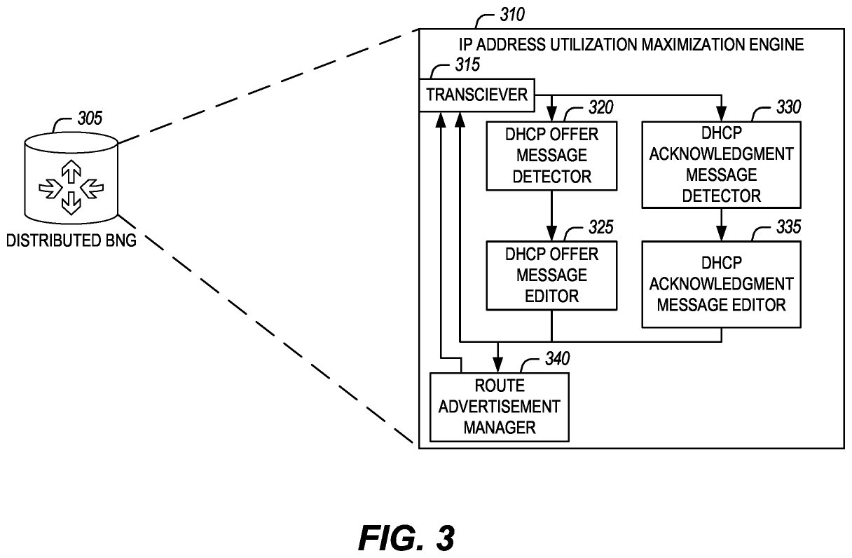

FIG. 3 is a block diagram of an example of a system 310 for a distributed broadband network gateway for maximizing IPv4 address utilization, according to an embodiment. The system 310 may be included with a distributed broadband network gateway (BNG) 305 (e.g., the first distributed BNG 210A as described in FIG. 2, etc.). In an example, the system 310 is an IP address utilization maximization engine. The system 310 may include a variety of components including a transceiver 315, a DHCP OFFER message detector 320, a DCHP OFFER message editor 325, a DHCP acknowledgment (ACK) message detector 330, a DHCP ACK message editor, and a route advertisement manager 340.

The components of the system 310 may be implemented as hardware devices (e.g., dedicated physical components, field programable gate arrays, application specific integrated circuits, etc.) or may be implemented in software (e.g., as computer instructions stored on computer-readable media and executed by at least one hardware processor, etc.) of the distributed BNG 505.

The transceiver 315 works in conjunction with the DHCP OFFER message detector 320 to receive a DHCP OFFER message at the distributed BNG 305 connected to a network. The DHCP offer message may have been forwarded from a DHCP server (e.g., the DHCP server 205 as described in FIG. 2, etc.). In an example, the network may be a passive optical network. In an example, the network may be an active ethernet network.

The DHCP OFFER message editor 325 modifies the DHCP offer message to replace an option 1 subnet mask with a 32-bit subnet mask and replace an option 3 router address with an internet protocol address of the distributed BNG 305 to create a modified offer message. The modified offer message is transmitted to a user computing device (e.g., the first user equipment 220A as described in FIG. 2, etc.) by the transceiver 315. In an example, the user computing device and the distributed BNG 305 are connected via an access system (e.g., the first access system 215A as described in FIG. 2, etc.). In an example, the access system is a passive optical network, a digital subscriber line network, or an ethernet network.

The transceiver 315 works in conjunction with the DHCP ACK message detector 330 to receive a DHCP ACK message at the distributed BNG 305 that was forwarded from the DHCP server. The DHCP ACK message editor 335 modifies the DHCP acknowledgement message to replace an option 1 subnet mask with a 32-bit subnet mask and replace an option 3 router address with the internet protocol address of the distributed BNG 305 to create a modified acknowledgement message. The modified acknowledgement message is transmitted to the user computing device via the transceiver 315.

The route advertisement manager 340 generates a route with a 32-bit subnet mask for the user computing device and advertises the route, in conjunction with the transceiver 315, to other routers internal to the network of a broadband service provider. In an example, the other routers are peer distributed BNGs (e.g., other distributed BNGs 210B and 210C as described in FIG. 2, etc.).

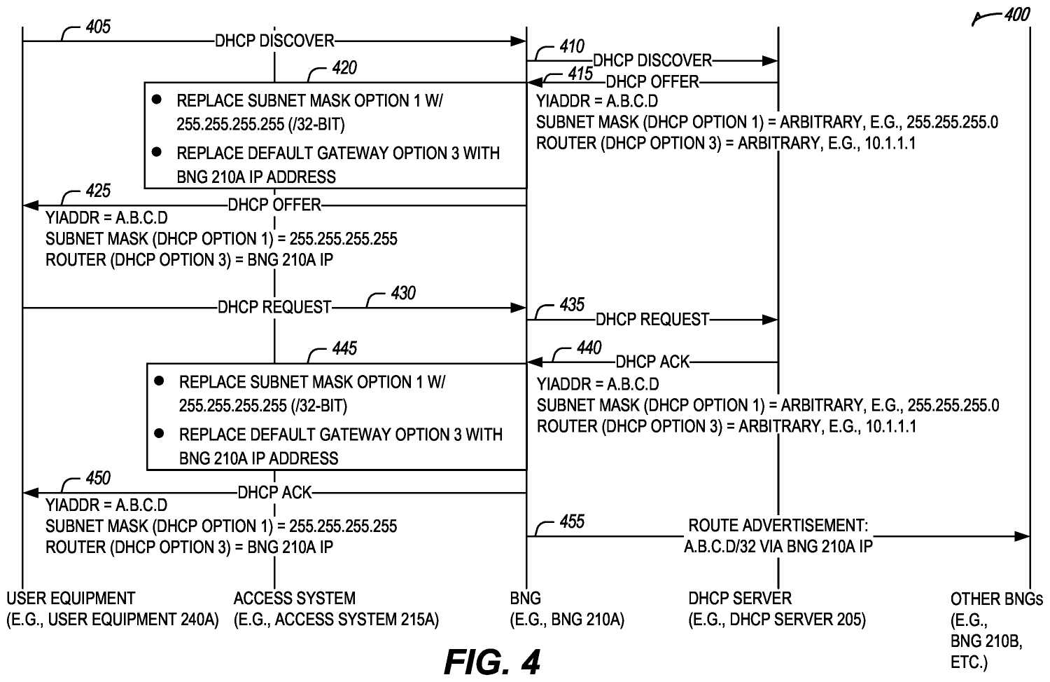

FIG. 4 is a dataflow diagram of an example of an address assignment process 400 for a distributed broadband network gateway for maximizing IPv4 address utilization, according to an embodiment. The address assignment process 400 also simplifies IP address management. The dataflow 400 may provide features as described in FIGS. 2 and 3.

At operation 405, user equipment (e.g., user equipment 240A as described in FIG. 2, etc.) issues a standard DHCP DISCOVER message. At operation 410, a distributed broadband network gateway (BNG) (e.g., the first distributed BNG 210A as described in FIG. 2, etc.) connected to an access system (e.g., the first access system 215A as described in FIG. 2, etc.) is configured to forward the DHCP DISCOVER message to a configured DHCP server (e.g., the DHCP server 205 as described in FIG. 2, etc.). At operation 415, the configured DHCP server responds to the BNG with a DHCP OFFER message. At operation 420, the BNG modifies the DHCP OFFER message from the DHCP server by replacing the subnet mask DHCP option with 255.255.255.255 (/32) and replaces the default gateway option with its own IP address. At operation 425, the BNG transmits the modified DHCP OFFER to the user equipment through the access system. At operation 430, the user equipment issues a DHCP REQUEST to accept the DHCP OFFER message. At operation 435, the BNG forwards the DHCP REQUEST to the DHCP server. At operation 440, the DHCP server returns a DHCP ACK message. At operation 445, the BNG modifies the DHCP ACK message from the DHCP server by replacing the subnet mask DHCP option with 255.255.255.255 (/32) and replaces the default gateway option with its own IP address. At operation 450, the BNG transmits the modified DHCP ACK to the user equipment through the access system. At operation 455, the BNG advertises a route to other connected BNGs (e.g., the BNGs 210B and 210C as described in FIG. 2, etc.) using an interior gateway protocol indicating that an IP address of a subscriber is reachable at the IP address of the BNG.

Rather than wasting subnet space through small subnets or having a large layer-2 network with its associated issues, the service provider is provided the ability to manage their entire subnet space as a single pool while at the same time terminating a subscriber VLAN at the BNG connected to the access systems. This enables the service provider to route subscriber traffic through the core of the network instead of bridging it directly or through a layer-2 virtual private network (VPN).

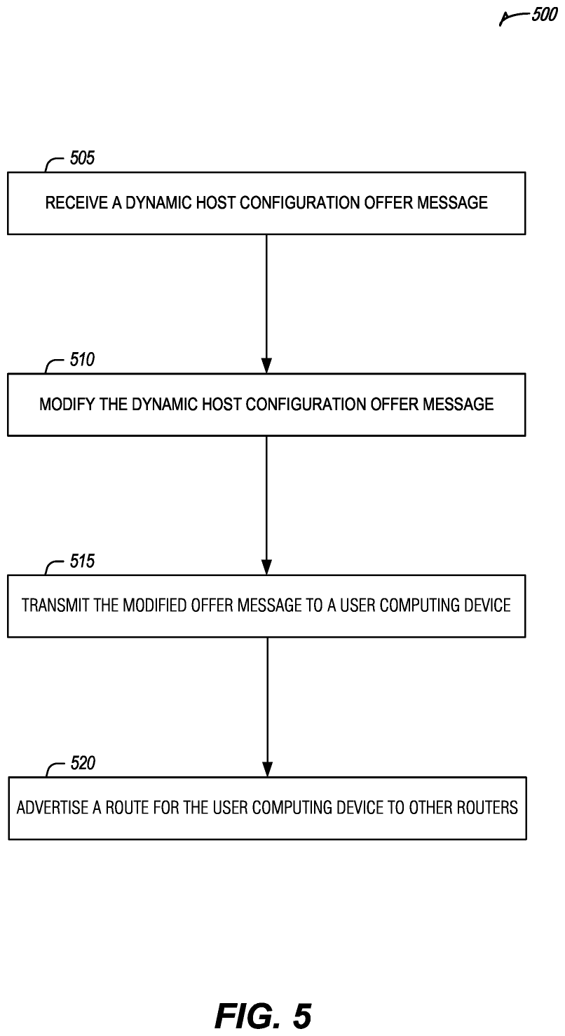

FIG. 5 is a flow diagram of an example of a method 500 for a distributed broadband network gateway for maximizing IPv4 address utilization, according to an embodiment. The method 500 may provide features as described in FIGS. 2 to 4.

A dynamic host configuration protocol (DHCP) offer message is received by a distributed broadband network gateways (BNG) connected to a network (e.g., at operation 505). The DHCP offer message may have been forwarded from a DHCP server. In an example, the network is a passive optical network. In an example, the network is an active ethernet network.

The DHCP offer message is modified to replace an option 1 subnet mask with a 32-bit subnet mask and replace an option 3 router address with an internet protocol address of the distributed BNG to create a modified offer message (e.g., at operation 510).

The modified offer message is transmitted to a user computing device (e.g., at operation 515). In an example, the user computing device and the distributed BNG are connected via an access system. In an example, the access system is a passive optical network, a digital subscriber line network, or an ethernet network.

In an example, a DHCP acknowledgement message may be received by the distributed broadband network gateway (BNG) that was forwarded from the DHCP server. The DHCP acknowledgement message may be modified to replace an option 1 subnet mask with a 32-bit subnet mask and replace an option 3 router address with the internet protocol address of the BNG to create a modified acknowledgement message. The modified acknowledgement message may be transmitted to the user computing device.

A route with a 32-bit subnet mask for the user computing device is advertised to other routers internal to the network of the broadband service provider (e.g., at operation 520). In an example, the other routers are peer distributed BNGs.

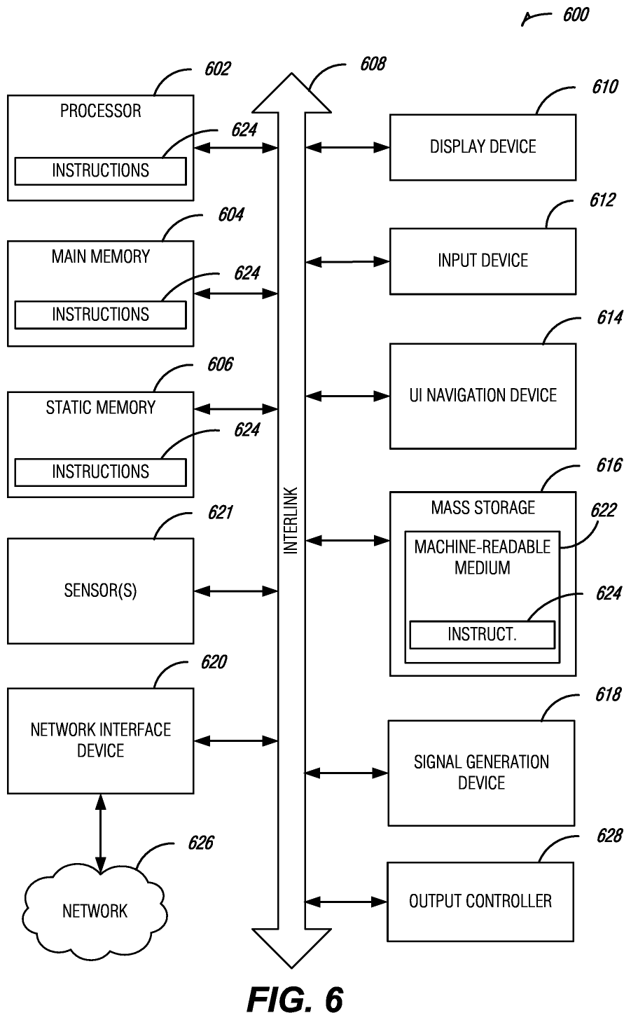

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensors. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### ADDITIONAL NOTES AND EXAMPLES

Example 1 is a distributed broadband network gateway (BNG) for reducing complexity of controlling bandwidth consumed by subscribers and managing IPv4 addresses for subscribers of a broadband service provider comprising: at least one processor; and memory including instructions that, when executed by the at least one processor, cause the at least one processor to perform operations to: receive a dynamic host configuration protocol (DHCP) offer message forwarded from a DHCP server via a network; modify the DHCP offer message to replace an option 1 subnet mask with a 32-bit subnet mask and replace an option 3 router address with an internet protocol address of the distributed BNG to create a modified offer message; and transmit the modified offer message to a user computing device; and advertise a route with a 32-bit subnet mask for the user computing device to other routers internal to the network of the broadband service provider.

In Example 2, the subject matter of Example 1 includes, the memory further comprising instructions that, when executed by at least one processor, cause the at least one processor to perform operations to: receive a DHCP acknowledgement message forwarded from the DHCP server via the network; modify the DHCP acknowledgement message to replace an option 1 subnet mask with a 32-bit subnet mask and replace an option 3 router address with the internet protocol address of the distributed BNG to create a modified acknowledgement message; and transmit the modified acknowledgement message to the user computing device.

In Example 3, the subject matter of Examples 1-2, wherein the user computing device and the distributed BNG are connected via an access system.

In Example 4, the subject matter of Example 3, wherein the access system is a passive optical network, a digital subscriber line network, or an ethernet network.

In Example 5, the subject matter of Examples 1-4, wherein the other routers are peer distributed BNGs.

In Example 6, the subject matter of Examples 1-5, wherein the network is a passive optical network.

In Example 7, the subject matter of Examples 1-6, wherein the network is an active ethernet network.

Example 8 is a method for reducing complexity of controlling bandwidth consumed by subscribers of a broadband service provider comprising: receiving, by a distributed broadband network gateway (BNG) connected to a network, a dynamic host configuration protocol (DHCP) offer message forwarded from a DHCP server; modifying the DHCP offer message to replace an option 1 subnet mask with a 32-bit subnet mask and replace an option 3 router address with an internet protocol address of the distributed BNG to create a modified offer message; and transmitting the modified offer message to a user computing device; and advertising a route with a 32-bit subnet mask for the user computing device to other routers internal to the network of the broadband service provider.

In Example 9, the subject matter of Example 8 includes, receiving, by the distributed BNG, a DHCP acknowledgement message forwarded from the DHCP server; modifying the DHCP acknowledgement message to replace an option 1 subnet mask with a 32-bit subnet mask and replace an option 3 router address with the internet protocol address of the distributed BNG to create a modified acknowledgement message; and transmitting the modified acknowledgement message to the user computing device.

In Example 10, the subject matter of Examples 8-9, wherein the user computing device and the distributed BNG are connected via an access system.

In Example 11, the subject matter of Example 10, wherein the access system is a passive optical network, a digital subscriber line network, or an ethernet network.

In Example 12, the subject matter of Examples 8-11, wherein the other routers are peer distributed BNGs.

In Example 13, the subject matter of Examples 8-12, wherein the network is a passive optical network.

In Example 14, the subject matter of Examples 8-13, wherein the network is an active ethernet network.

Example 15 is at least one non-transitory machine-readable medium including instructions for reducing complexity of controlling bandwidth consumed by subscribers of a broadband service provider that, when executed by at least one processor, cause the at least one processor to perform operations to: receive, by a distributed broadband network gateway (BNG) connected to a network, a dynamic host configuration protocol (DHCP) offer message forwarded from a DHCP server; modify the DHCP offer message to replace an option 1 subnet mask with a 32-bit subnet mask and replace an option 3 router address with an internet protocol address of the distributed BNG to create a modified offer message; and transmit the modified offer message to a user computing device; and advertise a route with a 32-bit subnet mask for the user computing device to other routers internal to the network of the broadband service provider.

In Example 16, the subject matter of Example 15 includes, instructions that, when executed by at least one processor, cause the at least one processor to perform operations to: receive, by the distributed BNG connected to the network, a DHCP acknowledgement message forwarded from the DHCP server; modify the DHCP acknowledgement message to replace an option 1 subnet mask with a 32-bit subnet mask and replace an option 3 router address with the internet protocol address of the distributed BNG to create a modified acknowledgement message; and transmit the modified acknowledgement message to the user computing device.

In Example 17, the subject matter of Examples 15-16, wherein the user computing device and the distributed BNG are connected via an access system.

In Example 18, the subject matter of Example 17, wherein the access system is a passive optical network, a digital subscriber line network, or an ethernet network.

In Example 19, the subject matter of Examples 15-18, wherein the other routers are peer distributed BNGs.

In Example 20, the subject matter of Examples 15-19, wherein the network is a passive optical network.

In Example 21, the subject matter of Examples 15-20, wherein the network is an active ethernet network.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A distributed broadband network gateway (BNG) for reducing complexity of controlling bandwidth consumed by subscribers of a broadband service provider comprising:
at least one processor; and
memory including instructions that, when executed by the at least one processor, cause the at least one processor to perform operations to:
receive a dynamic host configuration protocol (DHCP) offer message forwarded from a DHCP server via a network;
modify the DHCP offer message to replace an option 1 subnet mask with a 32-bit subnet mask and replace an option 3 router address with an internet protocol address of the distributed BNG to create a modified offer message; and
transmit the modified offer message to a user computing device; and
advertise a route with a 32-bit subnet mask for the user computing device to other routers internal to the network of the broadband service provider.

2. The system of claim 1, the memory further comprising instructions that, when executed by at least one processor, cause the at least one processor to perform operations to:
receive a DHCP acknowledgement message forwarded from the DHCP server via the network;
modify the DHCP acknowledgement message to replace an option 1 subnet mask with a 32-bit subnet mask and replace an option 3 router address with the internet protocol address of the distributed BNG to create a modified acknowledgement message; and
transmit the modified acknowledgement message to the user computing device.

3. The system of claim 1, wherein the user computing device and the distributed BNG are connected via an access system.

4. The system of claim 3, wherein the access system is a passive optical network, a digital subscriber line network, or an ethernet network.

5. The system of claim 1, wherein the other routers are peer distributed BNGs.

6. The system of claim 1, wherein the network is a passive optical network.

7. The system of claim 1, wherein the network is an active ethernet network.

8. A method for reducing complexity of controlling bandwidth consumed by subscribers of a broadband service provider comprising:
receiving, by a distributed broadband network gateway (BNG) connected to a network, a dynamic host configuration protocol (DHCP) offer message forwarded from a DHCP server;
modifying the DHCP offer message to replace an option 1 subnet mask with a 32-bit subnet mask and replace an option 3 router address with an internet protocol address of the distributed BNG to create a modified offer message; and
transmitting the modified offer message to a user computing device; and
advertising a route with a 32-bit subnet mask for the user computing device to other routers internal to the network of the broadband service provider.

9. The method of claim 8, further comprising:
receiving, by the distributed BNG, a DHCP acknowledgement message forwarded from the DHCP server;
modifying the DHCP acknowledgement message to replace an option 1 subnet mask with a 32-bit subnet mask and replace an option 3 router address with the internet protocol address of the distributed BNG to create a modified acknowledgement message; and
transmitting the modified acknowledgement message to the user computing device.

10. The method of claim 8, wherein the user computing device and the distributed BNG are connected via an access system.

11. The method of claim 10, wherein the access system is a passive optical network, a digital subscriber line network, or an ethernet network.

12. The method of claim 8, wherein the other routers are peer distributed BNGs.

13. The method of claim 8, wherein the network is a passive optical network.

14. The method of claim 8, wherein the network is an active ethernet network.

15. At least one non-transitory machine-readable medium including instructions for reducing complexity of controlling bandwidth consumed by subscribers of a broadband service provider that, when executed by at least one processor, cause the at least one processor to perform operations to:
receive, by a distributed broadband network gateway (BNG) connected to a network, a dynamic host configuration protocol (DHCP) offer message forwarded from a DHCP server;
modify the DHCP offer message to replace an option 1 subnet mask with a 32-bit subnet mask and replace an option 3 router address with an internet protocol address of the distributed BNG to create a modified offer message; and
transmit the modified offer message to a user computing device; and
advertise a route with a 32-bit subnet mask for the user computing device to other routers internal to the network of the broadband service provider.

16. The at least one non-transitory machine-readable medium of claim 15, further comprising instructions that, when executed by at least one processor, cause the at least one processor to perform operations to:
receive, by the distributed BNG connected to the network, a DHCP acknowledgement message forwarded from the DHCP server;
modify the DHCP acknowledgement message to replace an option 1 subnet mask with a 32-bit subnet mask and replace an option 3 router address with the internet protocol address of the distributed BNG to create a modified acknowledgement message; and
transmit the modified acknowledgement message to the user computing device.

17. The at least one non-transitory machine-readable medium of claim 15, wherein the user computing device and the distributed BNG are connected via an access system.

18. The at least one non-transitory machine-readable medium of claim 17, wherein the access system is a passive optical network, a digital subscriber line network, or an ethernet network.

19. The at least one non-transitory machine-readable medium of claim 15, wherein the other routers are peer distributed BNGs.

20. The at least one non-transitory machine-readable medium of claim 15, wherein the network is a passive optical network.
